(19) United States
(12) Patent Application Publication
(10) Pub. No.: US 2017/0165855 A1
(43) Pub. Date: Jun. 15, 2017

(54) Cutting Jig System

(71) Applicants: Larry Stevens, Ennismore (CA); Josh Burdick, Ennismore (CA)

(72) Inventors: Larry Stevens, Ennismore (CA); Josh Burdick, Ennismore (CA)

(21) Appl. No.: 14/964,661

(22) Filed: Dec. 10, 2015

(51) Int. Cl. B26B 29/06; B26D 7/20

(52) U.S. Cl. CPC B26B 29/06; B26D 7/20

(57) ABSTRACT

A cutting jig system for cutting insulation panels to a selected length includes a panel. A box is provided and the panel is positionable within the box. The box has a guide and the guide extends laterally across the panel when the panel is positioned within the box. A knife is insertable through the guide and the knife may be slid along the guide. The knife cuts the panel such that the panel is trimmed to a selected length.

### BACKGROUND OF THE DISCLOSURE

### Field of the Disclosure

The disclosure relates to cutting devices and more particularly pertains to a new cutting device for cutting insulation panels to a selected length.

### SUMMARY OF THE DISCLOSURE

An embodiment of the disclosure meets the needs presented above by generally comprising a panel. A box is provided and the panel is positionable within the box. The box has a guide and the guide extends laterally across the panel when the panel is positioned within the box. A knife is insertable through the guide and the knife may be slid along the guide. The knife cuts the panel such that the panel is trimmed to a selected length.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a cutting jig system in a closed position according to an embodiment of the disclosure.

FIG. 2 is a perspective view of an embodiment of the disclosure in an open position.

FIG. 3 is a front view of an embodiment of the disclosure.

FIG. 4 is a top view of an embodiment of the disclosure.

FIG. 5 is a left side view of an embodiment of the disclosure.

### DESCRIPTION OF THE PREFERRED EMBODIMENT

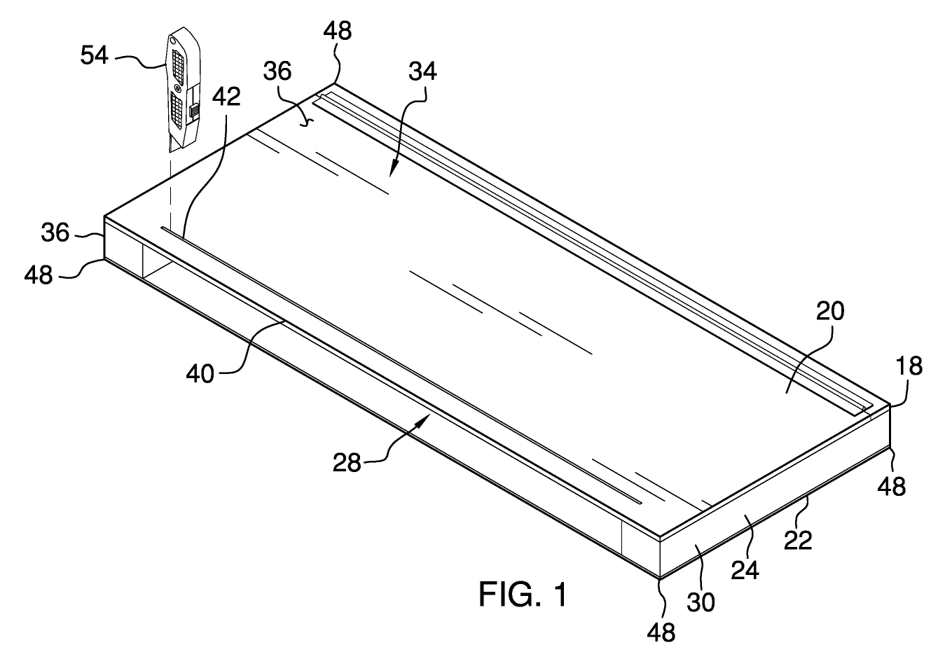

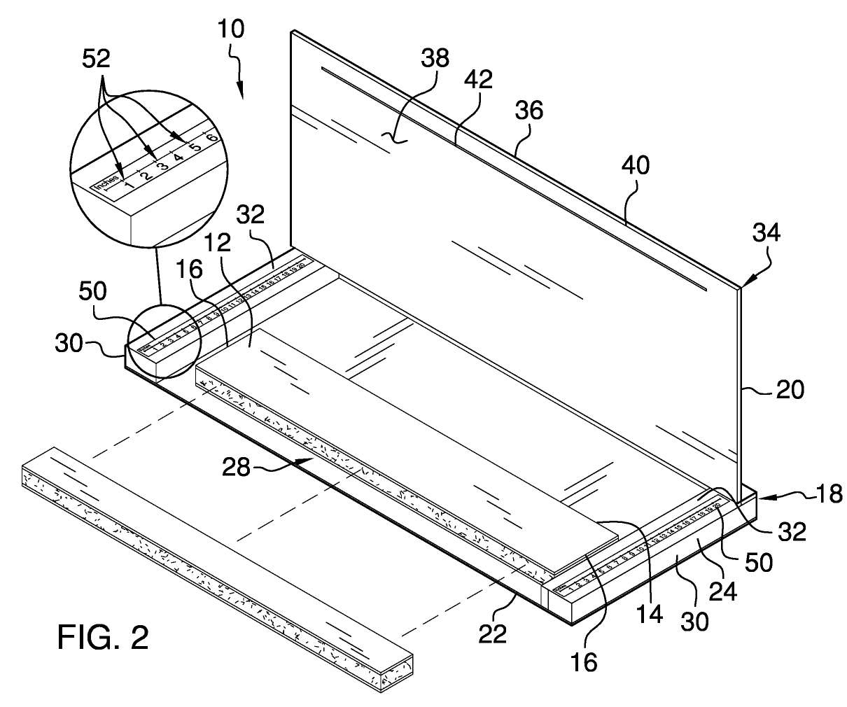

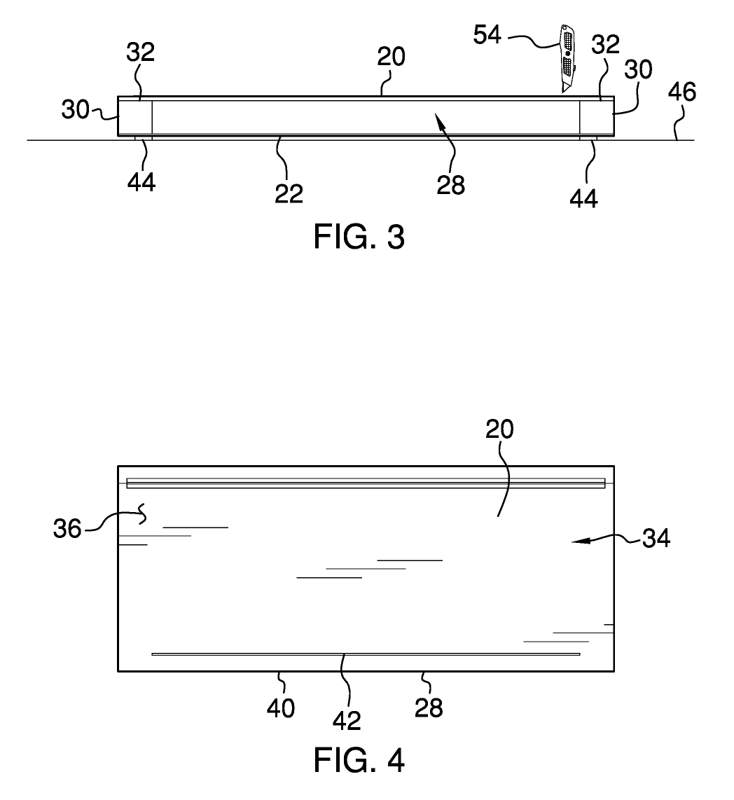

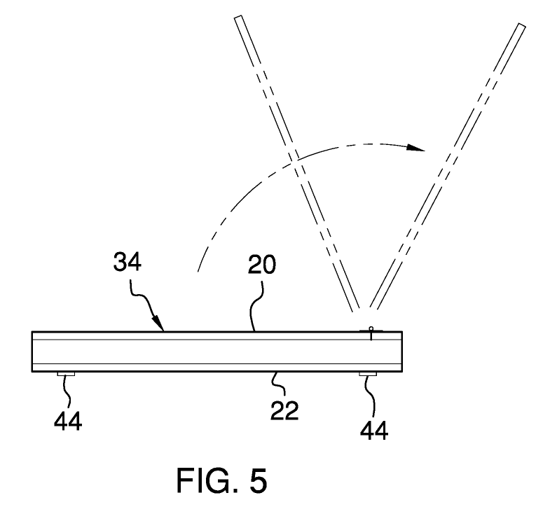

With reference now to the drawings, and in particular to FIGS. 1 through 5 thereof, a new cutting device embodying the principles and concepts of an embodiment of the disclosure and generally designated by the reference numeral 10 will be described.

As best illustrated in FIGS. 1 through 5, the cutting jig system 10 generally comprises a panel 12 that has a front edge 14 and a pair of lateral edges 16. The panel 12 may comprise fiberglass insulation or the like. A box 18 is provided and the box 18 has a top wall 20, a bottom wall 22 and a peripheral wall 24 extending between top wall 20 and the bottom wall 22. The bottom wall 22 has a bottom surface 26. The peripheral wall 24 has a front side 28 and a pair of lateral sides 30. Each of the lateral sides 30 has a top edge 32 and the front side 28 is open such that the panel 12 is extendable through the front side 28.

The top wall 20 has a hinged section 34 and the hinged section 34 is positionable in an open position to expose an interior of the box 18. The hinged section 34 is positionable in a closed position having the hinged section 34 resting on the top edge 32 of each of the lateral sides 30. The hinged section 34 has a top surface 36, a bottom surface 38 and a front edge 40. The hinged section 34 has a slot 42 extending through the top surface 36 and the bottom surface 38. The slot 42 is substantially coextensive with the front edge 40 of the hinged section.

A plurality of feet 44 is provided. Each of the feet 44 is coupled to the bottom surface 26 of the bottom wall 22. Thus, each of the feet 44 may abut a support surface 46. Each of the feet 44 is positioned proximate an associated one of four corners 48 of said box 18. Each of the feet 44 may be comprised of a resiliently compressible material thereby enhancing a grip of the feet 44 on the support surface 46.

A pair of rulers 50 is provided and each of the rulers 50 is coupled to the top edge 32 of an associated one of the lateral sides 30. Each of the rulers 50 has numbers 52 printed thereon. The front edge 14 of the panel 12 is aligned with a selected one of the numbers 52 when the panel 12 is positioned within the box 18. Each of the rulers 50 may have a length ranging between approximately fifty cm and 60 cm.

A knife 54 is provided and the knife 54 is insertable through the slot 42. The knife 54 is manipulated to be slid along the slot 42. The knife 54 extends through the slot 42 and cuts the panel 12 when the knife 54 is manipulated. Thus, the panel 12 is trimmed to a selected length corresponding to the selected numbers 52 on each of the rulers 50. The knife 54 may comprise a utility knife or the like. The box 18 inhibits fibers of the panel 12 from being disbursed into the atmosphere when the panel 12 is cut.

In use, the hinged section 34 is positioned in the open position and the panel 12 is positioned within the box 18 such that the panel 12 extends outwardly from the front side 28 of the box 18. The front edge 14 of the panel 12 is aligned with the selected numbers 52 on each of the rulers 50. The hinged section 34 is positioned in the closed position and the knife 54 is extended through the slot 42. The knife 54 is manipulated laterally along the slot 42 such that the knife 54 cuts the panel 12 to the selected length. The hinged section 34 is positioned in the open position and the selected length of the panel 12 is removed from the box 18. The process is repeated to produce a selected number of the selected lengths of the panel 12.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cutting jig system comprising:
a panel;
a box having said panel being positioned therein, said box having a guide, said guide extending laterally across said panel when said panel is positioned within said box; and
a knife being insertable through said guide wherein said knife is configured to be slid along said guide, said knife cutting said panel such that said panel is trimmed to a selected length.

2. The system according to claim 1, wherein said box has a top wall, a bottom wall, and a peripheral wall extending between top wall and said bottom wall, said peripheral wall having a front side and a pair of lateral sides, each of said lateral sides having a top edge, said front side being open such that said panel is extendable through said front side, said top wall having a hinged section.

3. The system according to claim 2, wherein said hinged section is positionable in an open position to expose an interior of said box, said hinged section being positionable in a closed position having said hinged section resting on said top edge of each of said lateral sides, said hinged section having a top surface, a bottom surface and a front edge, said hinged section having a slot extending through said top surface and said bottom surface to define said guide, said slot being substantially coextensive with said front edge.

4. The system according to claim 2, further comprising a pair of rulers, each of said rulers being coupled to said top edge of an associated one of said lateral sides, each of said rulers having numbers being printed thereon, said panel being aligned with a selected one of said numbers when said panel is positioned within said box.

5. A cutting jig system comprising:
a panel having a pair of lateral edges;
a box having said panel being positioned therein, said box having a guide, said guide extending laterally across said panel when said panel is positioned within said box, said box having a top wall, a bottom wall, and a peripheral wall extending between top wall and said bottom wall, said peripheral wall having a front side and a pair of lateral sides, each of said lateral sides having a top edge, said front side being open such that said panel is extendable through said front side, said top wall having a hinged section, said hinged section being positionable in an open position to expose an interior of said box, said hinged section being positionable in a closed position having said hinged section resting on said top edge of each of said lateral sides, said hinged section having a top surface, a bottom surface and a front edge, said hinged section having a slot extending through said top surface and said bottom surface to define said guide, said slot being substantially coextensive with said front edge;
a pair of rulers, each of said rulers being coupled to said top edge of an associated one of said lateral sides, each of said rulers having numbers being printed thereon, said panel being aligned with a selected one of said numbers when said panel is positioned within said box;
a knife being insertable through said guide wherein said knife is configured to be slid along said guide, said knife extending through said slot and cutting said panel between said lateral edges such that said panel is trimmed to a selected length corresponding to said selected numbers on each of said rulers.
